(19) United States
(12) Patent Application Publication
(10) Pub. No.: US 2008/0302327 A1
(43) Pub. Date: Dec. 11, 2008

(54) Drain Valve

(76) Inventors: Erik Dahl, Goteborg (SE); Katarina Jemt, Goteborg (SE)

Correspondence Address: WRB-IP LLP, 1217 KING STREET, ALEXANDRIA, VA, 22314, US

(21) Appl. No.: 12/095,220

(22) PCT Filed: Nov. 16, 2006
(86) PCT No.: PCT/SE06/01298

§ 371 Date: May 28, 2008

(30) Foreign Application Priority Data
Dec. 16, 2005 (SE) 0502823-8

(51) Int. Cl. F02M 35/10

(52) U.S. Cl. 123/184.53

(57) ABSTRACT

A charge air cooler includes a drain arrangement for draining condensed matter from the internal space of the charge air cooler. The drain arrangement includes an opening in a bottom portion of the charge air cooler. At least one member is positioned to open and close the opening. The at least one member is controlled to close and open the opening responsive to temperature changes.

### BACKGROUND AND SUMMARY

The present invention relates to a charge air cooler comprising a drain arrangement for draining condensed matter from the internal space of the charge air cooler. The drain arrangement comprises an opening in a bottom portion of the charge air cooler, wherein at least one member is positioned to open and close said opening.

For turbocharged piston engines, it has more or less become industry standard to provide a charge air cooler between the turbocharger and the inlet of the engine. A charge air cooler cools the compressed, hot air from the turbocharger prior to engine inlet entrance. By this cooling, some important advantages, which per se are well known by persons skilled in the art, are achieved. For example, the engine will attain higher power, reduced fuel consumption and reduced emissions.

There are however some problems connected to the use of charge air coolers, the perhaps most severe problem being that water vapor in the compressed air is likely to condense in the charge air cooler. The condensed water will descend to a bottom portion of the charge air cooler, where it might block the path of the air flowing through the charge air cooler.

The problem with condensed water is even more serious during winter periods in areas where freezing temperatures occur. In freezing temperatures, the condensed water in the charge air cooler may freeze to ice. As is well known, ice tends to expand as compared to water; this expansion might ruin confined spaces where the freezing occurs, e.g. the charge air cooler. Furthermore, the ice might block the air path leading from the turbocharger to the engine. As can be understood, the engines running conditions will be severely disturbed if the air flow about to enter the engine is disturbed.

To avoid condensed water from gathering in charge air coolers, it is common to drill a small (diameter 1-10 mm) hole in a bottom portion of the charge air cooler. This hole will allow drainage of water from the charge air cooler, hence avoiding said problem with gathering of water. The provision of a hole is however disadvantageous from several points of view. Firstly, the hole will allow not only water, but also compressed air, to escape the charge air cooler. As can be understood, allowing compressed air to escape the charge air cooler contravenes the basic idea with the charge air cooler, namely to let in a larger air mass through the engine intake. Secondly, there is a major risk that a small hole gets blocked, which of course takes us back to point one, namely the problem with condensed water or ice blocking or ruining the charge air cooler. Thirdly, there are engine running condition where the pressure in the charge air cooler is lower than the ambient pressure. Under such conditions, air will be drawn into the charge air cooler through the small hole. The air passing into the charge air cooler through the small hole has not been filtered, which is the case for other intake air, which increases the risk of dirt or abrasive materials being allowed to enter the engine's sensitive combustion areas.

A fourth problem of the known technique is that it is less important, or even unnecessary, to have a drainage hole on markets where freezing temperatures are not present. On such markets, the small drainage hole might be omitted, which might lead to later problems if a secondhand engine is sold to a customer in a colder climate.

In one known design, a float valve is positioned to open the drainage hole when there is water in the charge air cooler. As the water is drained, the float valve will close the hole and stop further drainage and air leakage. There is however one serious drawback with using float valves, namely that they close, or start closing, before all the water is drained. Hence, there is a risk that not all water will be drained from the charge air cooler, which increases the risk of damage by freezing water. There is also a risk that such a valve sticks in the open or closed position.

Hence, it is desirable to present a drainage solution that can be used for all markets, that provides a sufficient drainage, reduces the risk of blocking, has a limited risk of sticking in an open or closed position, drains all present water and does not inflict compressed air leakage.

According to an aspect of the present invention, at least one member is controlled to close and open said opening responsive to temperature changes.

In a preferred embodiment, the member is a bimetal tongue arranged to cover the opening above a certain temperature and open the opening below said temperature. This embodiment is a simple and cost efficient solution to the problem. In some embodiments, the bimetal tongue is placed on an external surface of the charge air cooler.

The bimetal tongue may be made from nickel and steel sheet metal. This metal mixture is a well known mixture to attain plausible bimetal properties.

In another embodiment, a thermostat arrangement is connected to a valve plate opening and closing said opening responsive to temperature changes. This embodiment is slightly more complex, but is sensitive to actual air temperature, rather than charge air cooler temperature. This embodiment could be further developed in that a second valve plate could be placed on the outside of the charge air cooler, and be connected such that the second valve plate closes the opening when the temperature of the thermostat arrangement is under a predetermined temperature. This embodiment is beneficial in that the opening will be covered during a larger temperature span, hence avoiding dirt or abrasive material being sucked into the charge air cooler.

This effect could also be obtained by a second bimetal tongue arranged to open the opening over a second temperature and cover the opening under said second temperature wherein the second temperature is lower than the certain temperature.

### BRIEF DESCRIPTION OF THE DRAWINGS

Hereinafter, the invention will be explained by means of examples of preferred embodiments, with reference to the appended drawings, wherein:

FIG. 1 is a schematic view of a first embodiment of the invention, wherein a bimetal tongue is used to open and close an opening in a charge air cooler,

FIG. 2 is a schematic view of a second embodiment of the invention, wherein the bimetal tongue is placed on an outside of the charge air cooler,

FIG. 3 is a schematic view of a third embodiment of the invention, wherein two bimetal tongues are used to attain a limited temperature range in which the opening is open,

FIG. 4 is a schematic view of a fourth embodiment of the invention, wherein a thermostat is used to open and close the opening in the charge air cooler, and FIG. 5 is a schematic view of a fifth embodiment of the invention, wherein a thermostat arrangement is used to attain a limited temperature opening range.

In all figures, a portion of the charge air cooler is zoomed to show details of the draining.

### DETAILED DESCRIPTION OF PREFERRED EMBODIMENTS

In this description, like reference numerals will be used for like components of the embodiments.

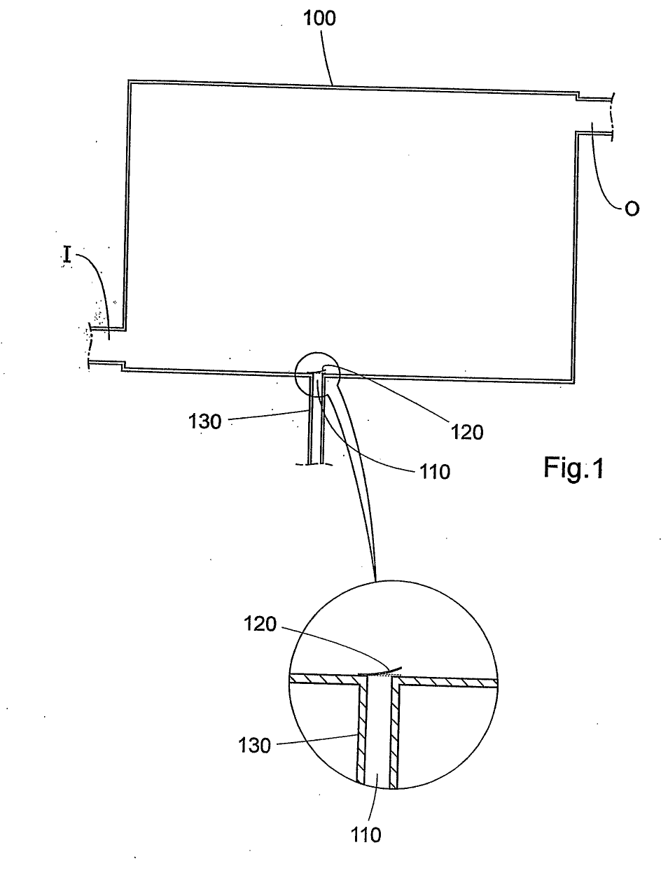

All figures show a charge air cooler 100 for a piston engine. The charge air cooler is of a standard type, and comprises an inlet I for hot compressed air from a turbocharger and an outlet O for cool compressed air for delivery to an engine intake. With reference to the FIGS. 1-3, the bottom portion of the charge air cooler 100 has an opening 110, which under certain conditions is covered by a bimetal tongue 120. In some cases, it could be advantageous if the opening 110 is connected to a nipple 130, e.g. for connection to a hose (not shown) for leading condensed matter to a spot where it could be discarded. In the embodiment shown in FIG. 1, the bimetal tongue is placed within the bottom portion 100 of the charge air cooler.

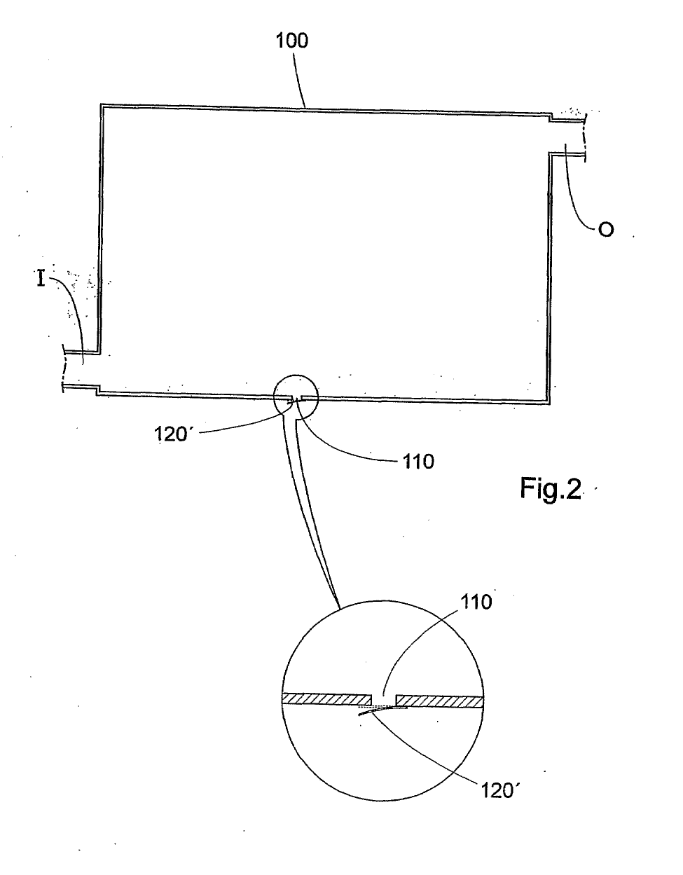

In FIG. 2, a similar embodiment as in FIG. 1 is shown, but a bimetal tongue 120′ is placed on the outside of the bottom portion.

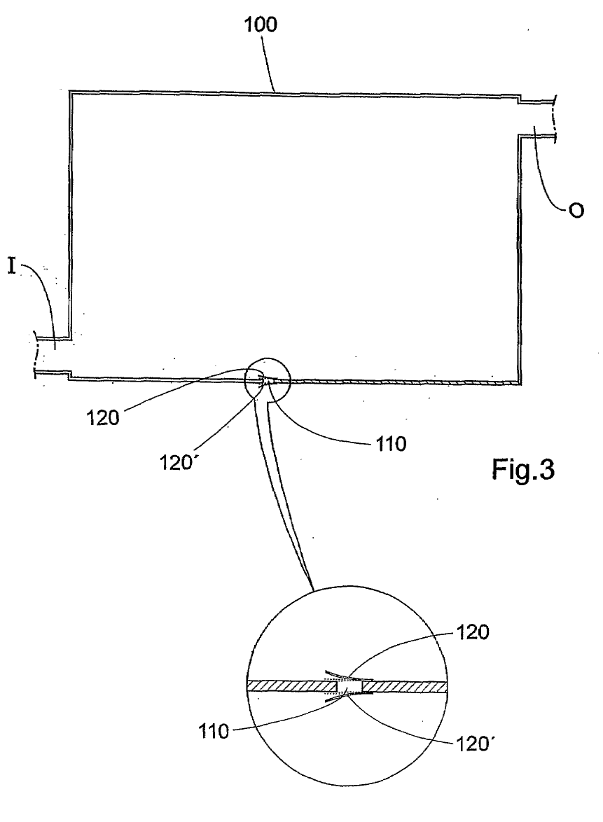

In FIG. 3, two bimetal tongues 120, 120′ are placed to cover the opening 110, wherein the bimetal tongue 120 is placed inside the charge air cooler 100, and the bimetal tongue 120′ is placed outside the charge air cooler. The function of this arrangement will be described later.

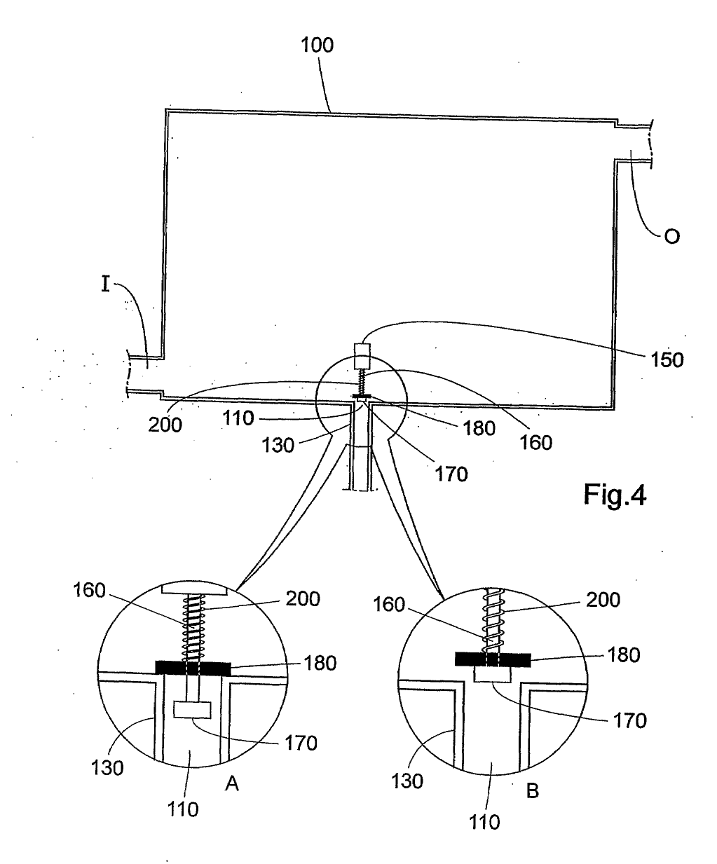

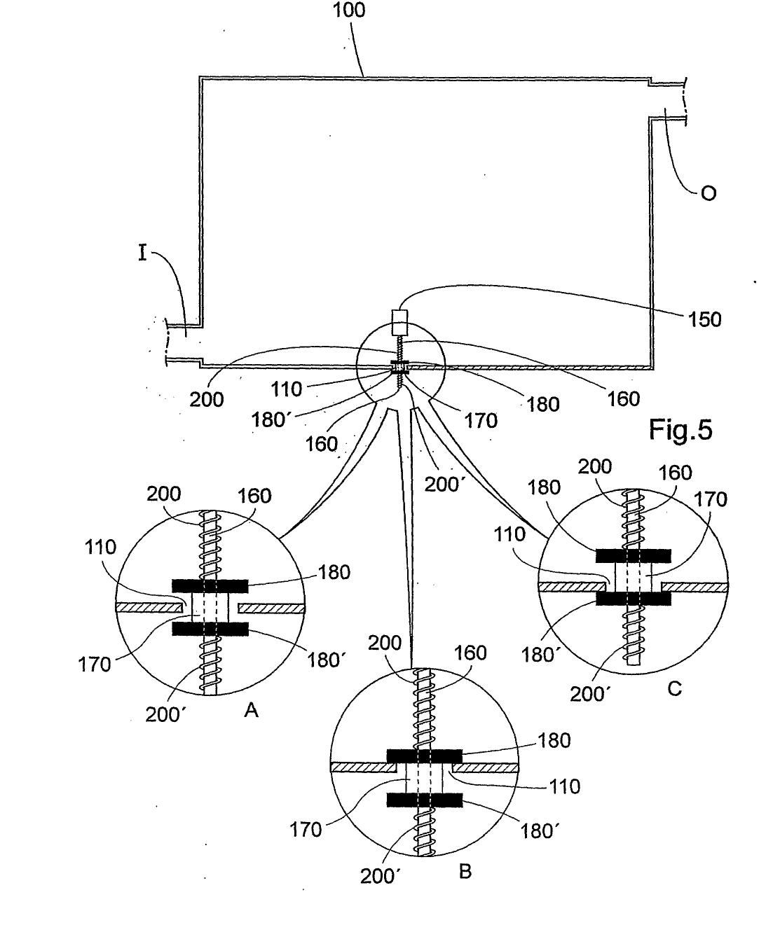

A somewhat different embodiment is shown in FIG. 4. In this embodiment, a thermostat housing 150 is placed within the bottom portion of the charge air cooler 100. A piston rod 160 connects the thermostat housing 150 and a valve plate 180. On the end of the piston rod, there is a stopper 170. The piston rod 160 and the valve plate 180 are connected in a gliding relationship, which means that the valve plate can glide “upwards” on the piston rod, i.e. away from the stopper 170. Furthermore, a spring 200 is placed between the thermostat housing 150 and the valve plate 180. The spring 200 biases the valve plate against the opening 110, or the stopper 170, and ensures that the valve plate is pressed towards the opening 110 when the piston rod is in an extended position. The spring 200 also ensures that the valve plate follows the stopper 170.

The fifth embodiment, shown in FIG. 5, resembles the embodiment shown in FIG. 4, but according to the fifth embodiment, a further valve plate 180′ is placed on the outside of the charge air cooler 100. The stopper 170 is placed in between the valve plates 180, 180′.

Hereinafter, the function of the invention will be described with reference to the above components.

The bimetal tongues 120, 120′ according to the first and second embodiments of the invention are conventional bimetal tongues which are designed to be straight under high temperature conditions and bent under low temperature conditions. As can be seen in FIGS. 1 and 2, straight bimetal tongues will close the opening 110, and bent bimetal tongues will open the openings 110. By this, a very beneficial effect is obtained, namely that the opening 110 will be closed during engine operation (when the air entering the charge air cooler is above a temperature where the bimetal tongue is straight enough to close the hole 110). When the engine is shut off, and the ambient temperature is low enough, the bimetal tongue will bend, hence leaving the opening 110 and allowing condensed matter to escape the bottom portion 100 of the charge air cooler.

Bimetal tongues are well known by persons skilled in the art, but the function of such tongues will nevertheless be briefly explained. Basically, a bimetal tongue comprises two sheets of metal that have been fused together, e.g. by—welding, brazing, gluing, soldering, explosion welding or any other means known in the art of metal joining. The metals used should have different thermal expansion properties. One common example of such metals is Nickel-steel. By fusing two metals with different thermal expansion, a metal piece having the desired properties, namely different bending upon temperature difference, can be obtained.

In the first and second embodiments, the opening 110 will be open at all temperatures below a certain threshold temperature, that e.g. could be 20 degrees C. It is however not desired to have an opening 110 being open at very low temperatures, e.g. some degrees below freezing temperature, since this increases the risk of inhaling dirt and impurities into the engine induction system. Since the most common condensate will be water, and water turns to ice at such low temperatures, an open hole would not drain water anyway. Having an open opening 110 increases the risk of inhaling dirt and impurities in the engine induction system. According to the third embodiment, the temperature range in which the opening 110 is open is minimized by providing two bimetal tongues 120, 120′ covering the opening 110, wherein the tongue 120 is placed on the inside of the charge air cooler and opens at temperatures over a high threshold value, e.g. 20 degrees C., and the other bimetal tongue 120′ is placed on the outside of the charge air cooler and closes the opening at temperatures below a low threshold value, e.g. −5 degrees C. By the third embodiment, a drain system having an unnecessary large temperature range in which the opening 110 is open can be avoided.

The embodiments shown in FIGS. 4 and 5 are functioning in a slightly different manner. The thermostat housing 150 is filled with a fluid (e.g. wax) that expands upon heating. The expansion of the fluid forces the piston rod 160 downwards, i.e. away from the thermostat housing 150. Since the spring 200 biases the valve plate 180 downwards, the valve plate 180 will rest upon the stopper 170 until it reaches the opening 110. When the valve plate has reached the opening 110, it will close the opening. The sliding arrangement between the valve plate and the piston rod makes it possible for the piston rod to continue its downward motion even after the valve plate 180 has closed the opening 110. The position where the valve plate 180 has reached the opening 110, and the stopper has moved to a position past the opening 110 is shown in zoomed portion a of FIG. 4. Zoom portion B shows an open position, i.e. a position where the valve plate 180 rests upon the stopper 170 well above the opening 110, hence leaving the opening in an open position allowing condensed matter to escape the charge air cooler 100.

In the fifth embodiment, shown in FIG. 5, the opening 110 will be open in a narrow temperature range, e.g. from 0 degrees C. to 20 degrees C. The open position is shown in zoom portion A in FIG. 5. Should the temperature reach a higher value than the above temperature range, the liquid in the thermostat housing 150 will expand and force the piston rod 160 downwards. The downward motion will bring the valve plate 180 placed on the inner side of the charge air cooler into engagement with the opening and close the opening, as shown in zoom portion B in FIG. 5. At temperatures below the narrow temperature range, the liquid in the thermostat housing will contract, forcing the piston rod upwards, which will bring the valve plate 180 placed outside the charge air cooler into contact with the opening 110, hence closing the opening 110 at lower temperatures (zoom portion C of FIG. 5).

One feature of the embodiment of FIGS. 4 and 5 is that the thermostat housing 150 reacts mainly on air temperature, since the thermostat housing is placed in the internal air stream. Hence, opening and closure of the opening 110 will be dependent on air temperature rather than the temperature of the charge air cooler closure, which mainly is the case for the bimetal tongue embodiments as shown in FIGS. 1, 2 and 3.

Another embodiment combines either of the above described embodiments with a one-way valve, e.g. a reed valve (not shown) connected to the opening 110 and arranged to allow outflow of liquid and air from the charge air cooler and stop inflow of air to the charge air cooler. Such an arrangement effectively stops unfiltered air from entering the charge air cooler, and allows simultaneously water and air to leave the charge air cooler whenever the bimetal tongues or thermostat arrangements as described above do not close the opening 110. As can be understood, the embodiment comprising a reed valve is most valuable for the first, second and fourth embodiments, i.e. the embodiments where the opening is open at low temperatures.

Several different embodiments of drain valves for charge air coolers have been shown and described. There is however nothing that excludes other embodiments using the principle of the invention, namely a system sensitive for temperature changes of the charge air coolers. The scope of the invention is defined in the appended claims.

1. Charge air cooler, comprising a drain arrangement for draining condensed matter from the internal space of the charge air cooler, the drain arrangement comprising an opening in a bottom portion of the charge air cooler, wherein at least one member is positioned to open and close the opening, wherein the at least one member is controlled to close and open the opening responsive to temperature changes.

2. The charge air cooler according to claim 1, wherein the member is a bimetal tongue arranged to cover the opening over a certain temperature and open the opening under the temperature.

3. The charge air cooler according to claim 2, wherein the bimetal tongue is placed on an external surface of the charge air cooler.

4. The charge air cooler according to claim 2, wherein the bimetal tongue is made from nickel and steel sheet metal.

5. The charge air cooler according to claim 1, wherein a thermostat arrangement is connected to a valve plate, the valve plate opening and closing the opening responsive to temperature changes.

6. The charge air cooler of claim 5, further comprising a second valve plate placed on the outside of the charge air cooler, the second valve plate being connected such that the second valve plate closes the opening when the temperature of the thermostat arrangement is under a predetermined temperature.

7. The charge air cooler of claim 2, further comprising a second bimetal tongue arranged to open the opening over a second temperature and cover the opening under the second temperature, wherein the second temperature is lower than the certain temperature.

8. The charge air cooler according to claim 1, wherein a one-way valve is connected to the opening and adapted to only allow outflow from the charge air cooler.
